(19) United States
(12) Patent Application Publication
(10) Pub. No.: US 2025/0353173 A1
(43) Pub. Date: Nov. 20, 2025

(54) INFORMATION PROCESSING DEVICE AND INFORMATION PROCESSING METHOD

(71) Applicant: SONY GROUP CORPORATION, TOKYO (JP)

(72) Inventors: KUNIAKI NODA, TOKYO (JP); TAKAYUKI SAKAMOTO, TOKYO (JP)

(21) Appl. No.: 18/854,690

(22) PCT Filed: Feb. 27, 2023
(86) PCT No.: PCT/JP2023/007103

§ 371 Date: Oct. 7, 2024

(30) Foreign Application Priority Data
Apr. 13, 2022 (JP) 2022-066157

(51) Int. Cl. B25J 9/16; G06T 7/521; G06T 7/73

(52) U.S. Cl. CPC B25J 9/1664; B25J 9/161; G06T 7/521; G06T 7/73; G06T 2207/10028; G06T 2207/20081

(57) ABSTRACT

To more stably determine the position and attitude of a hand gripping a target object.

An information processing device includes: a position/attitude estimation unit that, taking each of points included in point cloud data generated based on a sensing result for a target object as contact points, estimates, for each of the points, candidates for a position and an attitude of a hand that grips the target object; a target object shape estimation unit that estimates a shape of the target object based on a distribution of the candidates for the position and the attitude estimated for each of the points; and a position/attitude determination unit that determines the position and the attitude of the hand gripping the target object based on the shape of the target object estimated.

### TECHNICAL FIELD

The present disclosure relates to an information processing device and an information processing method.

### BACKGROUND ART

A manipulator device that grips a target object recognizes the target object based on sensing results from the various sensors, and then grips the recognized target object.

For example, PTL 1 below discloses a robot device that recognizes a target object through template matching against an image obtained by normalizing a captured image of the target object, and then grips the recognized target object.

However, with the technique disclosed in PTL 1, it is difficult to recognize unknown target objects not present in the template. Accordingly, recognizing the shape of a target object using a sensing result from a range sensor (i.e., depth data) is being investigated in recent years.

### Citation List

### Patent Literature

### PTL 1

JP 2017-87326A

### SUMMARY

### Technical Problem

However, when the sensing result from a range sensor is unstable, it is difficult to accurately recognize the shape of the target object. This makes it difficult to stably estimate the position and attitude of a hand capable of gripping the target object. Furthermore, the estimated position and attitude of the hand are less reliable, making it more likely that the hand will fail to grip the target object at the estimated position and attitude of the hand. There is thus a need to more stably determine the position and attitude of a hand gripping a target object when the sensing result for the target object is unstable.

Accordingly, the present disclosure proposes a new and improved information processing device and information processing method capable of more stably determining a position and attitude of a hand gripping a target object.

### Solution to Problem

According to the present disclosure, an information processing device is provided, including: a position/attitude estimation unit that, taking each of points included in point cloud data generated based on a sensing result for a target object as contact points, estimates, for each of the points, candidates for a position and an attitude of a hand that grips the target object; a target object shape estimation unit that estimates a shape of the target object based on a distribution of the candidates for the position and the attitude estimated for each of the points; and a position/attitude determination unit that determines the position and the attitude of the hand gripping the target object based on the shape of the target object estimated.

Additionally, according to the present disclosure, an information processing method is provided, the information processing method being performed by an arithmetic processing device, and including: estimating, having taken each of points included in point cloud data generated based on a sensing result for a target object as contact points, candidates for a position and an attitude of a hand that grips the target object, for each of the points; estimating a shape of the target object based on a distribution of the candidates for the position and the attitude estimated for each of the points; and determining the position and the attitude of the hand gripping the target object based on the shape of the target object estimated.

### BRIEF DESCRIPTION OF DRAWINGS

FIG. 1 is a schematic diagram illustrating the technical background of the present disclosure.

FIG. 2 is a block diagram illustrating the functional configuration of an information processing device according to one embodiment of the present disclosure.

FIG. 3 is a schematic diagram illustrating an example of point cloud data of a bottle placed on a flat surface such as a floor.

FIG. 4 is a schematic diagram illustrating, with emphasis, some points included in the point cloud data illustrated in FIG. 3 as contact points.

FIG. 5 is a schematic diagram illustrating candidates for positions and attitudes of a hand gripping a target object, at each of the contact points included in the point cloud data illustrated in FIG. 3.

FIG. 6 is a schematic diagram illustrating a relationship between a geometric shape of a hand that is a two-finger parallel gripper, and an estimated grip center of a target object.

FIG. 7 is a schematic diagram illustrating an example of a relationship between a distribution of a grip center of a target object and an orthogonal basis derived through principal component analysis.

FIG. 8 is a flowchart illustrating the flow of a determination made when a shape approximation unit approximates the shape of a target object to a basic shape.

FIG. 9A is a schematic diagram illustrating an example of positions and attitudes of a hand gripping a target object approximated to a sphere.

FIG. 9B is a schematic diagram illustrating an example of a position and an attitude of a hand gripping a target object approximated to a cylinder.

FIG. 9C is a schematic diagram illustrating an example of positions and attitudes of a hand gripping a target object approximated to a rectangular plate.

FIG. 9D is a schematic diagram illustrating an example of positions and attitudes of a hand gripping a target object not approximated to a basic shape.

FIG. 10 is a flowchart illustrating the flow of operations by an information processing device according to the same embodiment.

FIG. 11 is a block diagram illustrating the functional configuration of an information processing device according to a first variation.

FIG. 12 is a flowchart illustrating the flow of operations by the information processing device according to the first variation.

FIG. 13 is a schematic diagram illustrating a variation on a basic shape of a sphere stored in a basic shape model storage unit.

FIG. 14 is a schematic diagram illustrating a variation on a basic shape of a cylinder stored in the basic shape model storage unit.

FIG. 15 is a schematic diagram illustrating a variation on a basic shape of a rectangular plate stored in the basic shape model storage unit.

FIG. 16 is a block diagram illustrating an example of the hardware configuration of an information processing device according to one embodiment of the present disclosure.

### DESCRIPTION OF EMBODIMENTS

Preferred embodiments of the present disclosure will be described in detail below with reference to the accompanying drawings. Note that in the present specification and the drawings, components having substantially the same functional configuration will be denoted by the same reference numerals, and repeated descriptions thereof will be omitted.

The descriptions will be given in the following order.
1. Overview
2. Embodiment
2.1. Configuration of Information Processing Device
2.2. Operations of Information Processing Device
3. Variations
3.1. First Variation
3.2. Second Variation
4. Hardware Configuration

### <1. Overview>

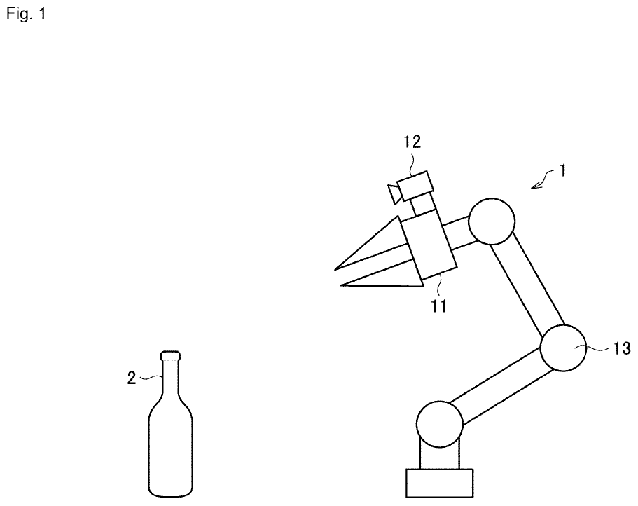

First, an overview of the technique according to the present disclosure will be described with reference to FIG. 1. FIG. 1 is a schematic diagram illustrating the technical background of the present disclosure.

As illustrated in FIG. 1, the technique according to the present disclosure is applied to a manipulation device 1 that grips a target object 2.

The manipulation device 1 includes, for example, a hand 11, a range sensor 12, and an arm 13. The manipulation device 1 is what is known as an articulated robotic arm device.

The hand 11 is an end effector having a mechanism capable of gripping the target object 2, and is attached to one end of the arm 13. The hand 11 may be a two-finger parallel gripper, for example. The range sensor 12 is a sensor capable of measuring the distance to the target object 2, and is attached to the hand 11. The range sensor 12 may be, for example, an RGB-D camera, an infrared ToF sensor, a LiDAR, a radar device, an ultrasonic sensor, a stereo camera, or the like. The arm 13 has a linking mechanism connecting a plurality of links to each other with a plurality of joints. The arm 13 is attached to, for example, a main body part of a mobile body capable of moving to any desired position, at another end opposite the one end to which the hand 11 is attached.

The manipulation device 1 having the configuration described above determines the position and attitude of the hand 11 capable of gripping the target object 2 by recognizing the shape of the target object 2 based on depth data of the target object 2 measured by the range sensor 12. However, the depth data of the target object 2 obtained by the range sensor 12 may destabilize due to the reflection or transmission of light at the surface of the target object 2, limitations on the capabilities of the range sensor 12, changes in the viewpoint of the range sensor 12, or the like.

The technique according to the present disclosure has been conceived in view of such circumstances. In the technique according to the present disclosure, candidates for the position and attitude of the hand 11 that grips the target object 2 are estimated from a sensing result obtained by the range sensor 12 sensing the target object 2, and the shape of the target object 2 is estimated based on a distribution of the estimated candidates for the position and attitude of the hand 11. By treating the estimated candidates for the position and attitude of the hand 11 as a distribution, the technique according to the present disclosure can, through averaging, suppress fluctuations or instability which occurs when making individual estimations. Accordingly, the technique according to the present disclosure can estimate the shape of the target object 2 with a higher accuracy, and thus the position and attitude of the hand 11 that grips the target object 2 can be determined with high accuracy and in a stable manner.

The following will describe the technique according to the present disclosure outlined above in more detail.

### <2. Embodiment>

### (2.1. Configuration of Information Processing Device)

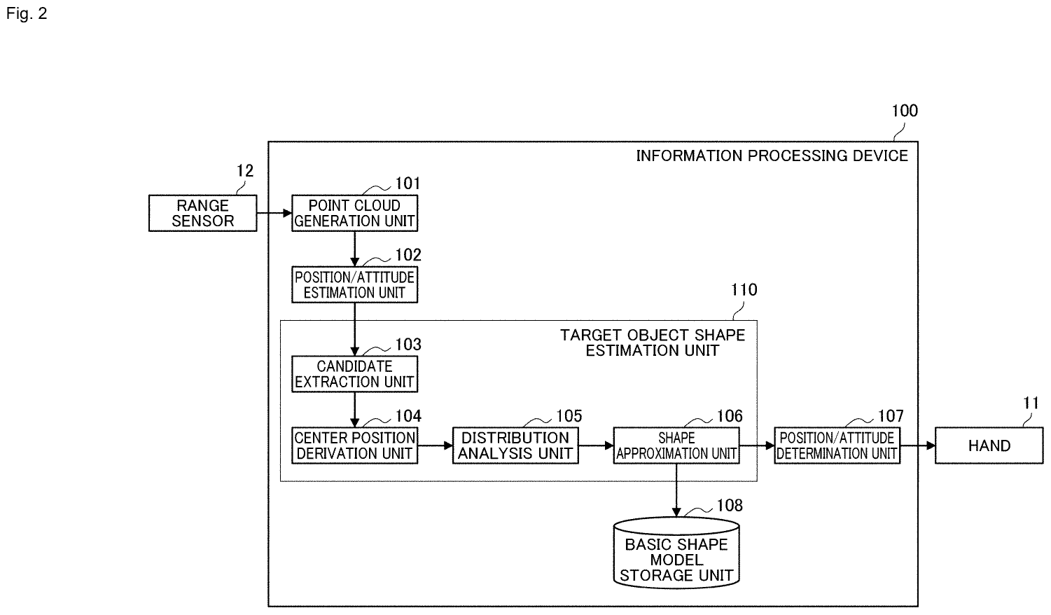

The configuration of an information processing device according to one embodiment of the present disclosure will be described next with reference to FIG. 2. FIG. 2 is a block diagram illustrating the functional configuration of an information processing device 100 according to the present embodiment.

As illustrated in FIG. 2, the information processing device 100 includes a point cloud generation unit 101, a position/attitude estimation unit 102, a target object shape estimation unit 110, a basic shape model storage unit 108, and a position/attitude determination unit 107.

The point cloud generation unit 101 generates point cloud data of the target object 2 based on a sensing result from the range sensor 12. Specifically, by comparing depth data measured by the range sensor 12 with an RGB image captured by an RGB camera whose positional relationship to the range sensor 12 is known, the point cloud generation unit 101 obtains three-dimensional coordinates corresponding to each pixel of the RGB image. Accordingly, by plotting a point corresponding to each pixel of the RGB image on the three-dimensional space, the point cloud generation unit 101 can generate point cloud data of the target object 2 included in the RGB image.

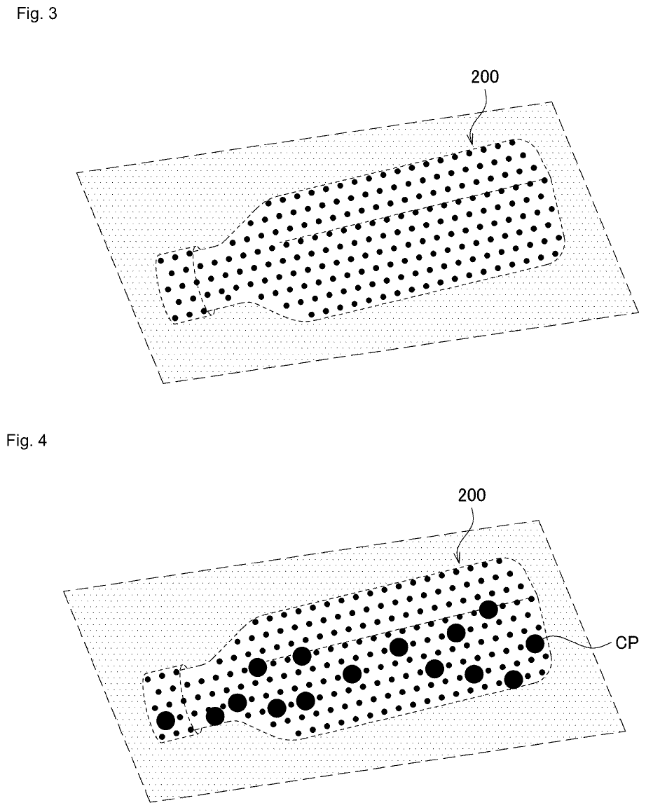

The point cloud generation unit 101 may generate point cloud data such as that illustrated in FIG. 3, for example. FIG. 3 is a schematic diagram illustrating an example of point cloud data 200 of a bottle placed on a flat surface such as a floor.

The position/attitude estimation unit 102 takes a point included in the point cloud data of the target object 2 as a contact point, and estimates candidates for the position and attitude of the hand 11 that grips the target object 2 for each contact point. Specifically, the position/attitude estimation unit 102 may use a machine learning model such as a deep neural network (DNN) to estimate the candidates for the position and attitude of the hand 11 that grips the target object 2 for each contact point.

The stated machine learning model is a machine learning model that has learned appropriate positions and attitudes of the hand 11 at the contact point, for each of geometric shapes of the fingers of the hand 11, through supervised learning. By inputting the point cloud data, the machine learning model can output the position and attitude of the hand 11, which takes each point included in the point cloud data as a contact point.

Note that the position/attitude estimation unit 102 may estimate candidates for the position and attitude of the hand 11 for some contact points CP selected from the points included in the point cloud data, as illustrated in FIG. 4. FIG. 4 is a schematic diagram illustrating, with emphasis, some points included in the point cloud data 200 data illustrated in FIG. 3 as contact points CP. The position/attitude estimation unit 102 can reduce the amount of computation for the estimation by estimating the candidates for the position and attitude of the hand 11 for some selected points, rather than all of the points included in the point cloud data.

The position/attitude estimation unit 102 may also derive a confidence level indicating a certainty of the estimation for each of the estimated candidates for the position and attitude of the hand 11. Through this, when estimating the shape of the target object 2 in a later stage, the target object shape estimation unit 110 in a later stage can selectively use candidates for the position and attitude of the hand 11 that have a higher confidence level. This makes it possible to further improve the accuracy of the estimation of the shape of the target object 2.

The target object shape estimation unit 110 estimates the shape of the target object 2 based on a distribution of the candidates for the position and attitude of the hand 11 estimated for each contact point CP. Specifically, by estimating the distribution of a grip center of the target object 2 based on the distribution of the estimated candidates for the position and attitude of the hand 11, the target object shape estimation unit 110 can estimate the shape of the gripped target object 2 through backwards calculation.

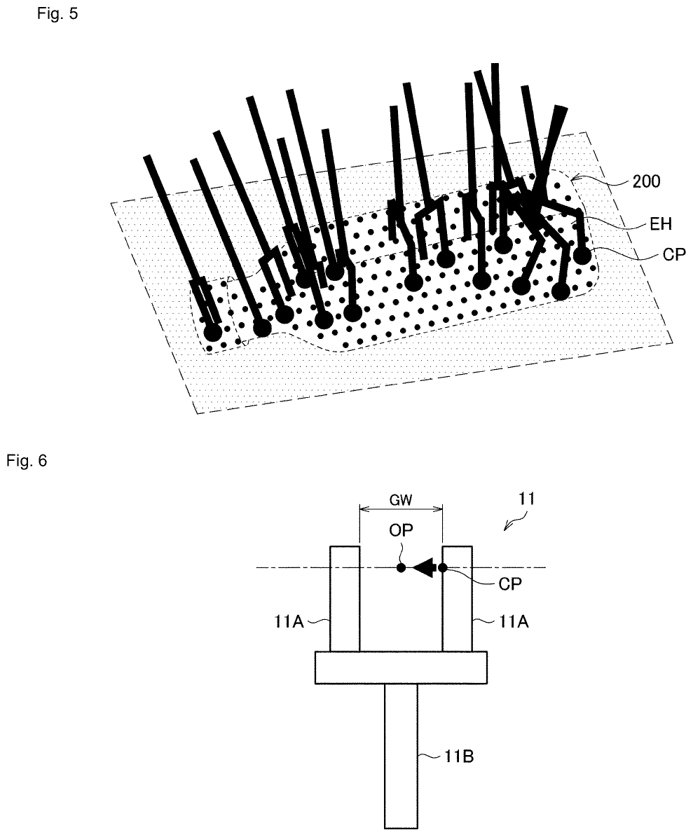

For example, the target object shape estimation unit 110 may estimate the shape of the target object 2 based on a distribution of candidates EH for the position and attitude of the hand 11 that grips the target object 2 at each of the contact points CP, as illustrated in FIG. 5. FIG. 5 is a schematic diagram illustrating candidates EH for positions and attitudes of the hand 11 gripping a target object 2, at each of the contact points CP included in the point cloud data 200 illustrated in FIG. 3.

Specifically, the target object shape estimation unit 110 includes a candidate extraction unit 103, a center position derivation unit 104, a distribution analysis unit 105, and a shape approximation unit 106.

Of the candidates for the position and attitude of the hand 11 estimated for each contact point CP, the candidate extraction unit 103 extracts candidates for the position and attitude to be used to estimate the shape of the target object 2. For example, as the candidates for the position and attitude to be used to estimate the shape of the target object 2, the candidate extraction unit 103 may extract candidates for the position and attitude of the hand 11 for which the estimated confidence level is at least a threshold. Through this, the target object shape estimation unit 110 can further improve the accuracy of the estimation of the shape of the target object 2, and reduce the amount of computation required to estimate the shape of the target object 2.

The center position derivation unit 104 estimates a distribution of the grip center of the target object 2 based on the estimated distribution of the candidates for the position and attitude of the hand 11.

The candidates for the position and attitude of the hand 11 estimated through machine learning assume that the target object 2 is gripped as a result of the grip center of the target object 2 being held within the geometric shape of the fingers of the hand 11. As such, the center position derivation unit 104 can estimate the grip center of the target object 2 from the estimated position, attitude, and geometric shape of the hand 11.

Through this, in addition to information about a front surface side of the target object 2 formed by the points included in the point cloud data, the target object shape estimation unit 110 can use information about a back surface, on the side opposite from the front surface, of the target object 2 to estimate the shape of the target object 2. Accordingly, the target object shape estimation unit 110 can use data that reflects the shape of the target object 2 in more detail than the point cloud data (that is, the distribution of the grip center of the target object 2) to estimate the shape of the target object 2.

The hand 11 is assumed to be a two-finger parallel gripper, as illustrated in FIG. 6, for example. FIG. 6 is a schematic diagram illustrating a relationship between the geometric shape of the hand 11, which is a two-finger parallel gripper, and the estimated grip center OP of the target object 2.

As illustrated in FIG. 6, the hand 11, which is a two-finger parallel gripper, includes a shaft part 11B, and a pair of finger parts 11A attached to the tip of the shaft part 11B so as to be parallel with each other. The hand 11, which is a two-finger parallel gripper, can grip the target object 2 between the finger parts 11A by narrowing a distance GW between the finger parts 11A while keeping the finger parts 11A parallel to each other.

The hand 11, which is a two-finger parallel gripper, is considered to grip the target object 2 by, for example, gripping a grip center OP of the target object 2 with the finger parts 11A at the contact points CP. As a result, the position/attitude estimation unit 102 estimates candidates for the position and attitude of the hand 11 such that the grip center OP of the target object 2 comes to an intermediate point on the tip side of the finger parts 11A. Accordingly, the center position derivation unit 104 can estimate the grip center OP of the target object 2 gripped by the hand 11 through reverse calculation using the estimated position and attitude of the hand 11 and the geometric shape of the hand 11. The center position derivation unit 104 can estimate the distribution of the grip center OP of the target object 2 by estimating the grip center OP of the target object 2 for each candidate for the position and attitude of the hand 11.

Through this, the center position derivation unit 104 can estimate detailed information about the shape of the target object 2 by using information about the geometric shape of the fingers of the hand 11 that grips the target object 2, in addition to the contact points CP on the front surface of the target object 2. Accordingly, the target object shape estimation unit 110 can estimate the shape of the target object 2 in more detail than when using only the point cloud data of the target object 2.

The distribution analysis unit 105 derives an orthogonal basis for the distribution of the grip center OP through principal component analysis on the estimated distribution of the grip center OP of the target object 2. Principal component analysis is a data analysis method that generates variables, called “principal components”, that best represent an overall variability, from a large number of correlated variables. The distribution analysis unit 105 can derive the orthogonal basis (i.e., vectors orthogonal to each other) that best represent the variability of the distribution of the grip center OP through principal component analysis on the estimated distribution of the grip center OP of the target object 2.

The orthogonal basis of the distribution of the grip center OP includes a first principal component vector, a second principal component vector, and a third principal component vector orthogonal to each other, for example. The first principal component vector is a vector corresponding to the direction having the largest spread in the distribution of the grip center OP of the target object 2. The second principal component vector is a vector corresponding to the direction, among the directions orthogonal to the first principal component vector, where the distribution of the grip center OP of the target object 2 is the largest. The third principal component vector is a vector corresponding to a direction orthogonal to both the first principal component vector and the second principal component vector.

The shape approximation unit 106 approximates the shape of the target object 2 to a basic shape based on a distribution width of the points included in the point cloud data in each vector direction of the orthogonal basis of the distribution of the grip center OP. Specifically, as a width in each direction of the target object 2, the shape approximation unit 106 first estimates a distance between a maximum value and a minimum value of each point in the point cloud data, in each of the directions of the first principal component vector, the second principal component vector, and the third principal component vector. Next, the shape approximation unit 106 approximates the shape of the target object 2 to any one of three basic shapes, namely a sphere, a cylinder, or a rectangular plate, based on a magnitude relationship between the distribution width of each point in the point cloud data in each vector direction of the orthogonal basis and a width between the fingertips of the hand 11.

The basic shape model storage unit 108 stores the basic shapes of the sphere, the cylinder, and the rectangular plate used by the shape approximation unit 106 to estimate the shape of the target object 2. The sphere a shape that can be gripped by the hand 11 in any direction. The cylinder is a shape that can be gripped by the hand 11 in any direction in a plane orthogonal to a height direction. The rectangular plate is a shape that can be gripped by the hand 11 only in a thickness direction, which is the normal direction of a main surface thereof. In other words, the three basic shapes, namely the sphere, the cylinder, and the rectangular plate, correspond to constraint conditions applied when the hand 11 grips the target object 2.

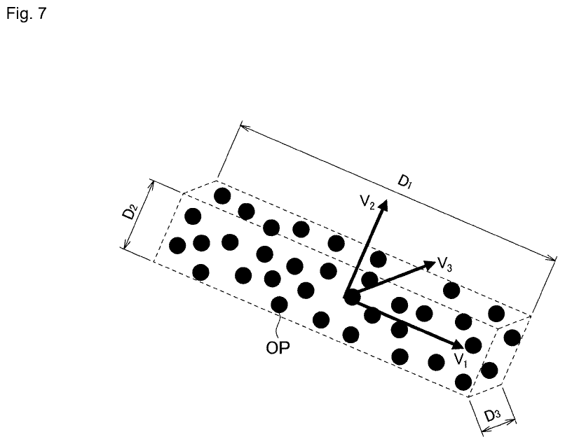

For example, FIG. 7 illustrates a relationship between the distribution of the grip center OP of the target object 2 and the orthogonal basis derived through principal component analysis. FIG. 7 is a schematic diagram illustrating an example of a relationship between the distribution of the grip center OP of the target object 2 and the orthogonal basis derived through principal component analysis.

As illustrated in FIG. 7, the shape approximation unit 106 derives the orthogonal basis (V₁, V₂, V₃) having vectors orthogonal to each other by performing principal component analysis on the estimated distribution of the grip center OP of the target object 2. Next, the shape approximation unit 106 derives distribution widths D₁, D₂, and D₃ of each point in the point cloud data, in each vector direction of the derived orthogonal basis (V₁, V₂, V₃). It should be noted that the first principal component vector V₁ is a vector in the direction where the spread of the distribution of the grip center OP is the largest, and the second principal component vector V₂ is a vector in the direction, among the directions orthogonal to the first principal component vector V₁, where the distribution of the grip center OP is the largest. The third principal component vector V₃ is a vector corresponding to a direction orthogonal to both the first principal component vector V₁ and the second principal component vector V₂. The shape approximation unit 106 can estimate the distribution widths D₁, D₂, and D₃ of each point in the point cloud data, in each vector direction of the orthogonal basis (V₁, V₂, V₃), as the width of the target object 2 in each vector direction.

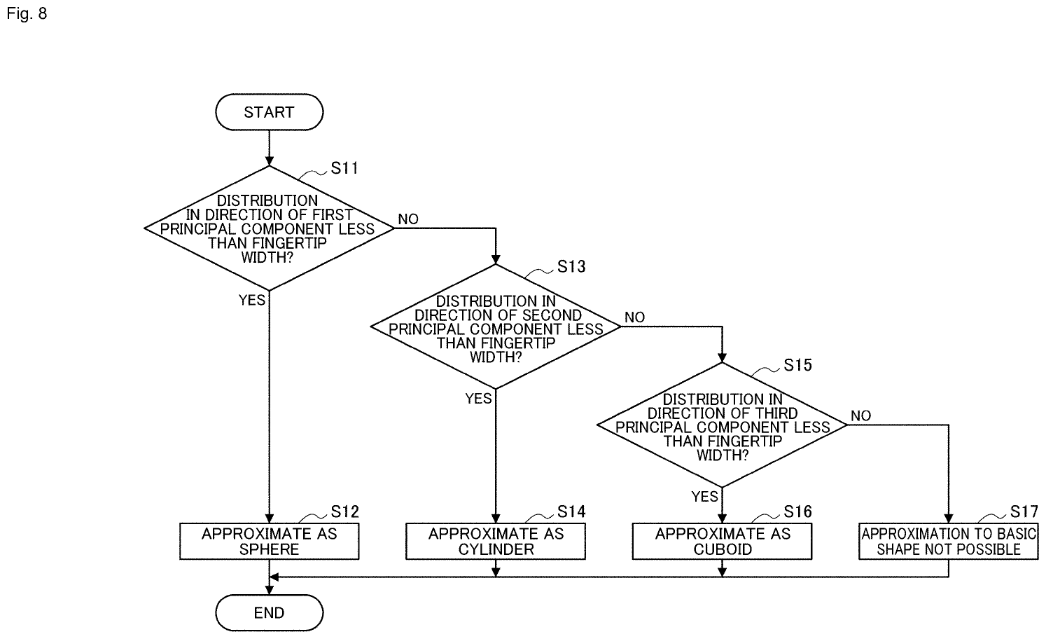

Next, the shape approximation unit 106 approximates the shape of the target object 2 to the any one basic shape among the sphere, the cylinder, or the rectangular plate, based on the flowchart illustrated in FIG. 8, for example. FIG. 8 is a flowchart illustrating the flow of a determination made when the shape approximation unit 106 approximates the shape of the target object 2 to a basic shape.

As illustrated in FIG. 8, first, the shape approximation unit 106 determines whether the distribution width D₁ in the direction of the first principal component vector V₁ is less than a maximum width between the fingertips of the hand 11 (i.e., a maximum width that can be gripped by the hand 11) (S11). If the distribution width D₁ in the direction of the first principal component vector V₁ is less than the maximum width between the fingertips of the hand 11 (S11/Yes), the distribution width D₂ in the direction of the second principal component vector V₂ and the distribution width D₃ in the direction of the third principal component vector V₃ will also be less than the maximum width between the fingertips of the hand 11. Accordingly, the shape approximation unit 106 can approximate the shape of the target object 2 to the basic shape of the sphere (S12).

Meanwhile, if the distribution width D₁ in the direction of the first principal component vector V₁ is at least the maximum width between the fingertips of the hand 11 (S11/No), the shape approximation unit 106 determines whether the distribution width D₂ in the direction of the second principal component vector V₂ is less than the maximum width between the fingertips of the hand 11 (S13). If the distribution width D₂ in the direction of the second principal component vector V₂ is less than the maximum width between the fingertips of the hand 11 (S13/Yes), the distribution width D₃ in the direction of the third principal component vector V₃ will also be less than the maximum width between the fingertips of the hand 11. Accordingly, the shape approximation unit 106 can approximate the shape of the target object 2 to the basic shape of a cylinder for which the direction of the first principal component vector V₁ is the height direction (S14).

Furthermore, if the distribution width D₂ in the direction of the second principal component vector V₂ is at least the maximum width between the fingertips of the hand 11 (S13/No), the shape approximation unit 106 determines whether the distribution width D₃ in the direction of the third principal component vector V₃ is less than the maximum width between the fingertips of the hand 11 (S15). If the distribution width D₃ in the direction of the third principal component vector V₃ is less than the maximum width between the fingertips of the hand 11 (S15/Yes), the shape approximation unit 106 can approximate the shape of the target object 2 to the basic shape of a rectangular plate in which the direction of the third principal component vector V₃ is the thickness direction (S16).

On the other hand, if the distribution width D₃ in the direction of the third principal component vector V₃ is at least the maximum width between the fingertips of the hand 11 (S15/No), the shape approximation unit 106 determines that the shape of the target object 2 cannot be approximated to the basic shapes of the sphere, the cylinder, or the rectangular plate (S17).

Accordingly, the target object shape estimation unit 110 can estimate the shape of the target object 2 by approximating the shape of the target object 2 to any basic shape among the sphere, the cylinder, or the rectangular plate.

The position/attitude determination unit 107 determines the position and attitude of the hand 11 that grips the target object 2 based on the estimated shape of the target object 2. Specifically, the position/attitude determination unit 107 determines the position and attitude of the hand 11 that grips the target object 2 based on the basic shape to which the target object 2 has been approximated.

In a target object 2 having the basic shape of a sphere, a cylinder, or a rectangular plate, constraint conditions arise with respect to the degree of freedom of the position and attitude of the hand 11 that grips the target object 2. Accordingly, the position/attitude determination unit 107 can determine the position and attitude of the hand 11 that grips the target object 2 based on the constraint conditions with respect to the degree of freedom set for each of the basic shapes.

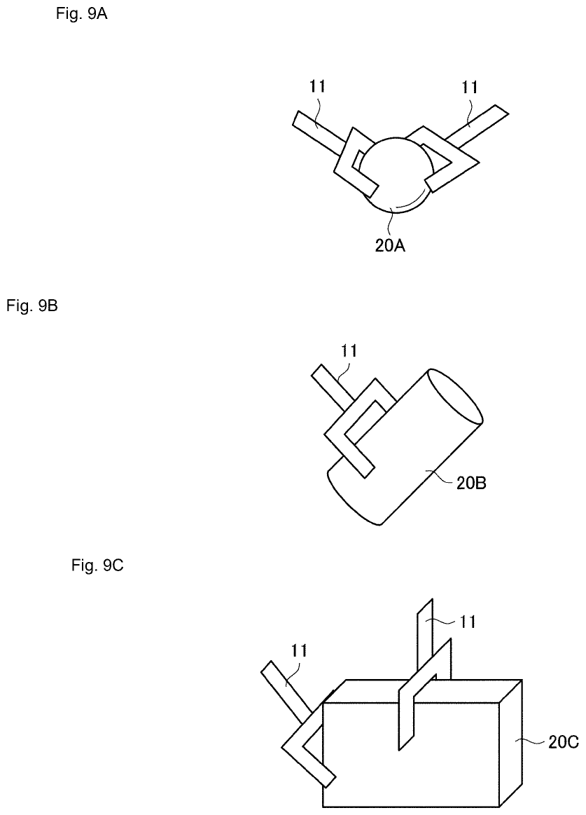

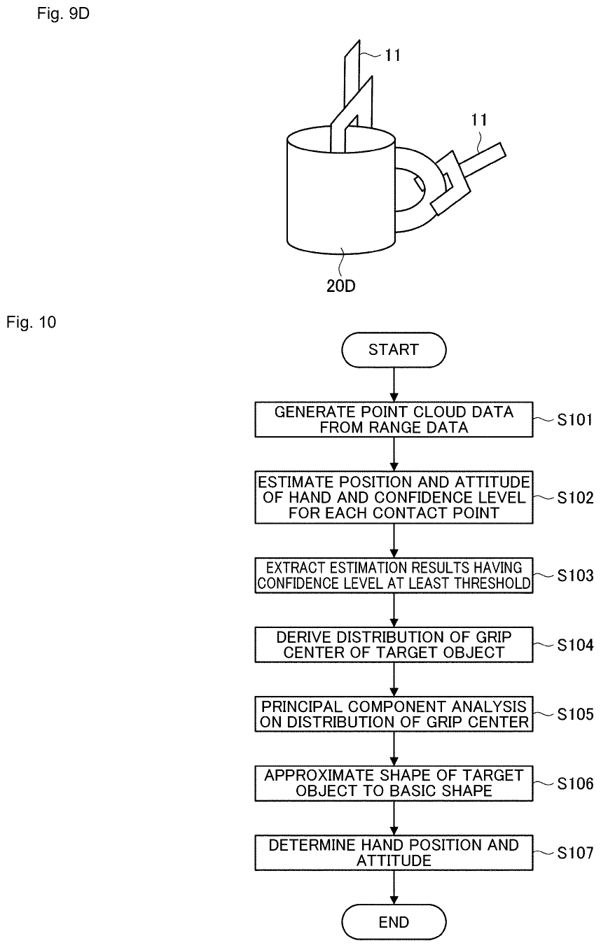

An example of a method for determining the position and attitude of the hand 11 with respect to the basic shapes of the sphere, the cylinder, and the rectangular plate, and a shape other than the basic shapes, will be described with reference to FIGS. 9A to 9D.

FIG. 9A is a schematic diagram illustrating an example of positions and attitudes of the hand 11 gripping a target object 20A approximated to a sphere. As illustrated in FIG. 9A, the target object 20A approximated to a sphere has a size smaller than a maximum width between the fingertips of the hand 11 (i.e., the maximum width that can be gripped by the hand 11) in all directions. As such, the hand 11 can grip the target object 20A from any direction without the degree of freedom thereof being constrained.

For example, the position/attitude determination unit 107 first derives, as the radius of the sphere, the average of distances between (i) the origin of the orthogonal basis of the distribution of the grip center OP of the target object 20A and (ii) each point in the point cloud data. Through this, the position/attitude determination unit 107 can determine the position and attitude of the hand 11 such that the fingertips of the hand 11 are positioned to grip the center of the sphere (i.e. the origin of the orthogonal basis) and the attitude of the hand 11 is horizontal or vertical.

FIG. 9B is a schematic diagram illustrating an example of positions and attitudes of the hand 11 gripping a target object 20B approximated to a cylinder. As illustrated in FIG. 9B, the target object 20B approximated to a cylinder has a size, in the height direction of the cylinder, that is at least the maximum width between the fingertips of the hand 11 (i.e., the maximum width that can be gripped by the hand 11). As such, the degree of freedom for the position and attitude of the hand 11 is constrained, and the hand 11 can grip the target object 20B from a direction in a plane orthogonal to the height of the cylinder.

For example, the position/attitude determination unit 107 first derives, as the radius of the cylinder, the average of distances between (i) the first principal component vector of the distribution of the grip center OP of the target object 20B and (ii) each point in the point cloud data. Next, the position/attitude determination unit 107 derives, as the height of the cylinder, the distribution width of each point in the point cloud data in the direction of the first principal component vector of the distribution of the grip center OP of the target object 20B. Through this, the position/attitude determination unit 107 can determine the position and attitude of the hand 11 such that the fingertips of the hand 11 are positioned to grip over the axis of the first principal component vector and the attitude of the hand 11 is parallel or perpendicular to the first principal component vector.

FIG. 9C is a schematic diagram illustrating an example of positions and attitudes of the hand 11 gripping a target object 20C approximated to a rectangular plate. As illustrated in FIG. 9C, the target object 20C approximated to a rectangular plate has a size, in a planar direction of a main surface of the rectangular plate, that is at least the maximum width between the fingertips of the hand 11 (i.e., the maximum width that can be gripped by the hand 11). As such, the degree of freedom for the position and attitude of the hand 11 is constrained, and the hand 11 can grip the target object 20C from the thickness direction of the rectangular plate.

For example, the position/attitude determination unit 107 first derives, as the lengths of three sides of the rectangular plate, a distribution width of each point in the point cloud data in each vector direction of the orthogonal basis of the distribution of the grip center OP of the target object 20C. Through this, the position/attitude determination unit 107 can determine the position and attitude of the hand 11 such that the fingertips of the hand 11 are positioned to grip the rectangular plate in the thickness direction, and the attitude of the hand 11 is perpendicular to a side surface of the rectangular plate.

FIG. 9D is a schematic diagram illustrating an example of positions and attitudes of the hand 11 gripping a target object 20D not approximated to a basic shape. As illustrated in FIG. 9D, the target object 20D not approximated to a basic shape has unknown constraint conditions with respect to the degree of freedom of the position and attitude of the hand 11. Accordingly, the position/attitude determination unit 107 may determine, as the position and attitude of the hand 11, the candidates having the highest confidence level among the positions and attitudes of the hand 11 estimated by the position/attitude estimation unit 102.

According to the configuration described above, the information processing device 100 according to the present embodiment can estimate the shape of the target object 2 based on a distribution of the candidates for the position and attitude of the hand 11 estimated from sensing result for the target object 2 from the range sensor 12. Through this, by treating the estimated candidates for the position and attitude of the hand 11 as a distribution, the information processing device 100 can average out fluctuations or instability arising in the individual estimations, and estimate the shape of the target object 2 in a more stable manner.

Furthermore, by approximating the shape of the target object 2 to a basic shape, namely a sphere, a cylinder, or a rectangular plate, the information processing device 100 according to the present embodiment can constrain the degree of freedom of the position and attitude of the hand 11 that grips the target object 2. Through this, the information processing device 100 can limit a search range used in the calculations when determining the position and attitude of the hand 11 that grips the target object 2, and thus the position and attitude of the hand 11 can be determined more quickly.

### (2.2. Operations of Information Processing Device)

Operations of the information processing device 100 according to the present embodiment will be described next with reference to FIG. 10. FIG. 10 is a flowchart illustrating the flow of the operations by the information processing device 100 according to the present embodiment.

As illustrated in FIG. 10, first, the point cloud generation unit 101 generates point cloud data from range data measured by the range sensor 12 (S101). Next, the position/attitude estimation unit 102 estimates candidates for the position and attitude of the hand 11 for each point in the point cloud data, along with a confidence level for each estimation (S102). Next, the candidate extraction unit 103 extracts the candidates for which the confidence level is at least a threshold from the estimated candidates for the position and attitude of the hand 11 (S103). Then, the center position derivation unit 104 derives the distribution of the grip center of the target object 2 by the hand 11 based on the distribution of the candidates for the position and attitude of the hand 11 (S104). Next, the distribution analysis unit 105 derives the orthogonal basis of the distribution of the grip center of the target object 2 through principal component analysis of the distribution of the grip center of the target object 2 (S105).

Next, the shape approximation unit 106 approximates the shape of the target object 2 to any one of the basic shapes, namely the sphere, the cylinder, or the rectangular plate, based on the orthogonal basis of the distribution of the grip center of the target object 2 (S106). Furthermore, the position/attitude determination unit 107 determines the position and attitude of the hand 11 based on the basic shape to which the target object 2 has been approximated (S107).

According to the flow of operations described above, the information processing device 100 according to the present embodiment can derive the position and attitude of the hand 11 capable of gripping the target object 2 in a stable manner, even when the sensing result from the range sensor 12 is unstable.

### <3. Variations>

### (3.1. First Variation)

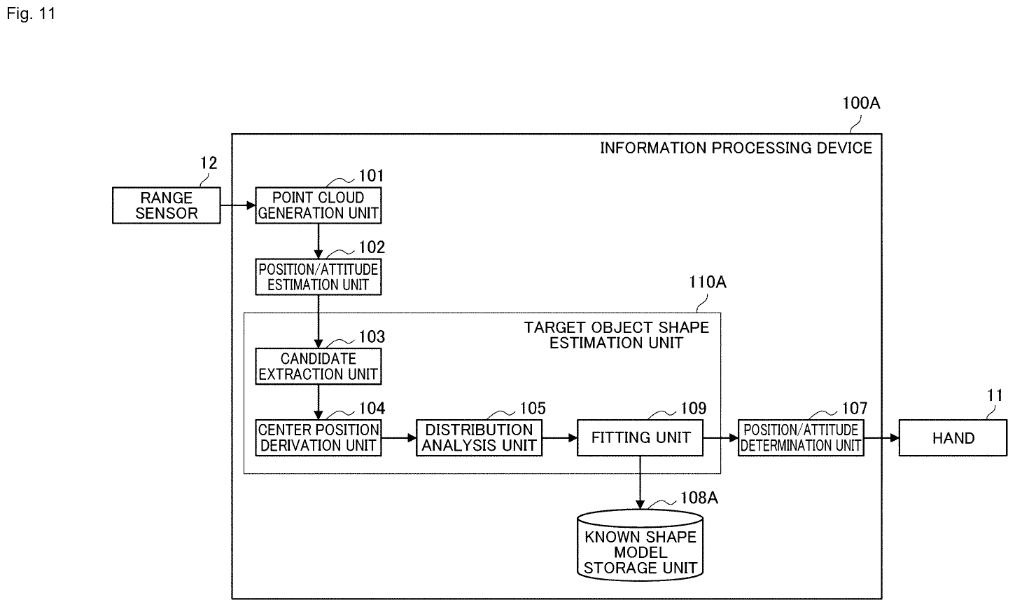

An information processing device 100A according to a first variation on the present embodiment will be described next with reference to FIG. 11. FIG. 11 is a block diagram illustrating the functional configuration of the information processing device 100A according to the first variation.

As illustrated in FIG. 11, the information processing device 100A includes the point cloud generation unit 101, the position/attitude estimation unit 102, a target object shape estimation unit 110A, a known shape model storage unit 108A, and the position/attitude determination unit 107. The configurations of the point cloud generation unit 101, the position/attitude estimation unit 102, and the position/attitude determination unit 107 are substantially the same as the configurations described with reference to FIG. 2, descriptions thereof will be omitted here.

When the shape of the target object 2 is known, the target object shape estimation unit 110A estimates the shape of the target object 2 by fitting a shape model stored in advance in the known shape model storage unit 108A with the distribution of the grip center OP of the target object 2. By fitting the shape model stored in the known shape model storage unit 108A with the distribution of the grip center OP of the target object 2 while constraining the degree of freedom using the respective orthogonal bases thereof, the target object shape estimation unit 110A can quickly estimate the shape of the target object 2.

Specifically, the target object shape estimation unit 110A includes the candidate extraction unit 103, the center position derivation unit 104, the distribution analysis unit 105, and a fitting unit 109.

As described with reference to FIG. 2, first, of the candidates for the position and attitude of the hand 11 estimated for each contact point CP, the candidate extraction unit 103 extracts candidates for the position and attitude to be used in the estimation in a later stage. Next, the center position derivation unit 104 estimates the distribution of the grip center of the target object 2 based on the extracted distribution of the candidates for the position and attitude of the hand 11. The distribution analysis unit 105 then derives an orthogonal basis for the distribution of the grip center OP through principal component analysis on the estimated distribution of the grip center OP of the target object 2.

By fitting the distribution of the grip center OP of the target object 2 with a known shape model, the fitting unit 109 estimates a shape model that matches the distribution of the grip center OP of the target object 2 as the shape of the target object 2. Specifically, by superimposing the orthogonal basis of the distribution of the grip center OP of the target object 2 and the orthogonal basis of the known shape model, the fitting unit 109 fits the distribution of the grip center OP of the target object 2 with the known shape model. Through this, by superimposing the orthogonal bases on each other, the fitting unit 109 can match the coordinate systems of the distribution of the grip center OP of the target object 2 and the known shape model in the three-dimensional space. Accordingly, the fitting unit 109 can constrain the degree of freedom of rotation between the distribution of the grip center OP of the target object 2 and the known shape model in the three-dimensional space, which makes it possible to perform the fitting of both more quickly.

The known shape model storage unit 108A stores a shape model corresponding to the shape of the target object 2 along with an orthogonal basis. The orthogonal basis of the shape model stored in the known shape model storage unit 108A is derived by performing the computational processing of the point cloud generation unit 101, the position/attitude estimation unit 102, the candidate extraction unit 103, the center position derivation unit 104, and the distribution analysis unit 105 in advance through a simulation, in the same manner as for the target object 2.

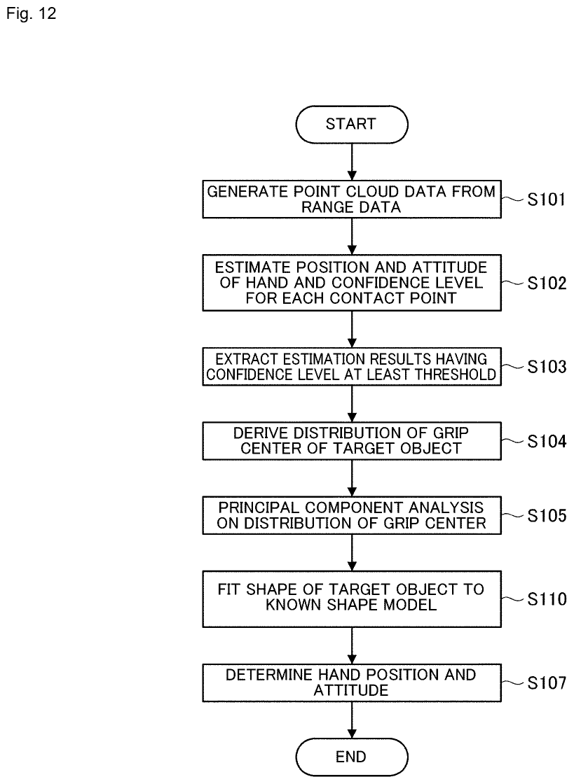

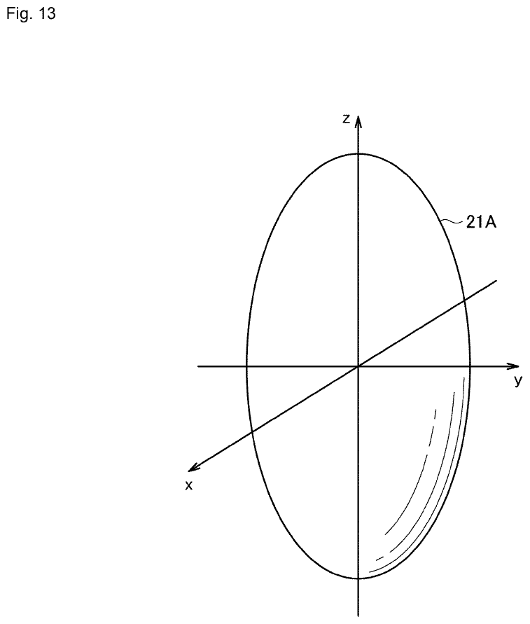

Operations of the information processing device 100A according to the first variation will be described next with reference to FIG. 12. FIG. 12 is a flowchart illustrating the flow of operations by the information processing device 100A according to the first variation.

As illustrated in FIG. 12, first, the point cloud generation unit 101 generates point cloud data from range data measured by the range sensor 12 (S101). Next, the position/attitude estimation unit 102 estimates candidates for the position and attitude of the hand 11 for each point in the point cloud data, along with a confidence level for each estimation (S102). Next, the candidate extraction unit 103 extracts the candidates for which the confidence level is at least a threshold from the estimated candidates for the position and attitude of the hand 11 (S103). Then, the center position derivation unit 104 derives the distribution of the grip center of the target object 2 by the hand 11 based on the distribution of the candidates for the position and attitude of the hand 11 (S104). Next, the distribution analysis unit 105 derives the orthogonal basis of the distribution of the grip center of the target object 2 through principal component analysis of the distribution of the grip center of the target object 2 (S105).

Next, by superimposing the orthogonal basis of the distribution of the grip center of the target object 2 and the orthogonal basis of the shape model stored in the known shape model storage unit 108A, the fitting unit 109 constrains the degree of freedom of the attitude in the three-dimensional space for both. With the degree of freedom of the attitude constrained, the fitting unit 109 matches the distribution of the grip center of the target object 2 with the shape model stored in the known shape model storage unit 108A. Through this, the fitting unit 109 can estimate the fitted shape model as the shape of the target object 2 (S110). Furthermore, the position/attitude determination unit 107 can determine the position and attitude of the hand 11 based on the shape of the target object 2 estimated through the fitting (S107).

The information processing device 100A according to the first variation matches the distribution of the grip center OP of the target object 2 with the shape model stored in the known shape model storage unit 108A while constraining the degree of freedom using the orthogonal basis. This enables the information processing device 100A to estimate the shape of the target object 2 more quickly.

### (3.2. Second Variation)

A second variation on the present embodiment will be described next with reference to FIGS. 13 to 15. FIGS. 13 to 15 are schematic diagrams illustrating variations on the basic shapes of the sphere, the cylinder, and the rectangular plate stored in the basic shape model storage unit 108.

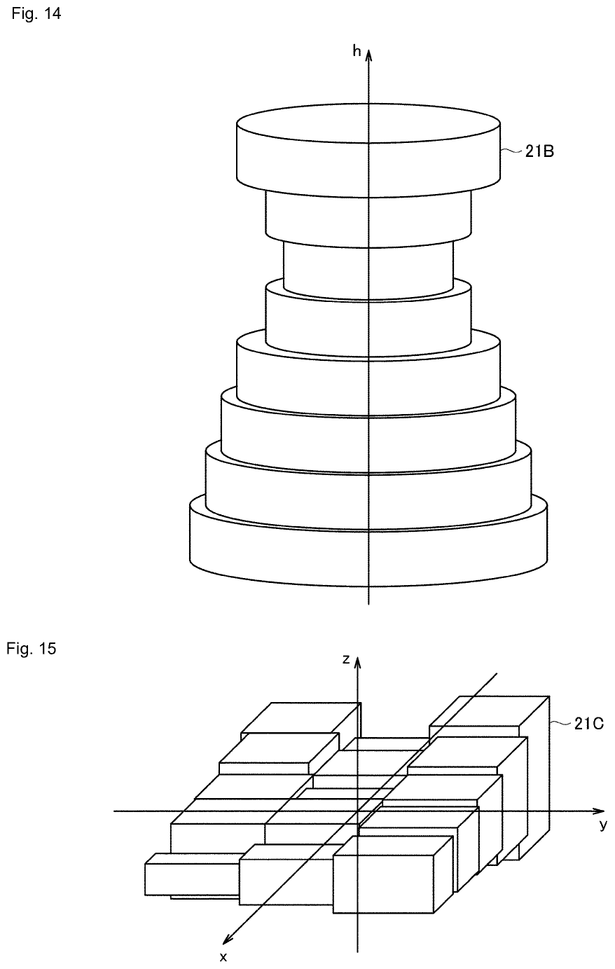

For example, the basic shape model storage unit 108 may store an ellipsoid, such as that illustrated in FIG. 13, as a basic shape that is more expressive than a sphere. The basic shape model storage unit 108 may also store a cylinder having a radius that varies in the height direction, such as that illustrated in FIG. 14, as a basic shape that is more expressive than a cylinder. Furthermore, the basic shape model storage unit 108 may store a rectangular plate having a thickness that varies from region to region of the main surface thereof, such as that illustrated in FIG. 15, as a basic shape that is more expressive than a rectangular plate.

According to the second variation, the shape approximation unit 106 can approximate the shape of the target object 2 to a basic shape that can express more detail. Accordingly, the position/attitude determination unit 107 in a later stage can determine a more stable position and attitude as the position and attitude of the hand 11. For example, the position/attitude determination unit 107 in the later stage can determine, as the position and attitude of the hand 11, a position and attitude at which the hand 11 grips a narrowed part more suited to being gripped.

### <4. Hardware Configuration>

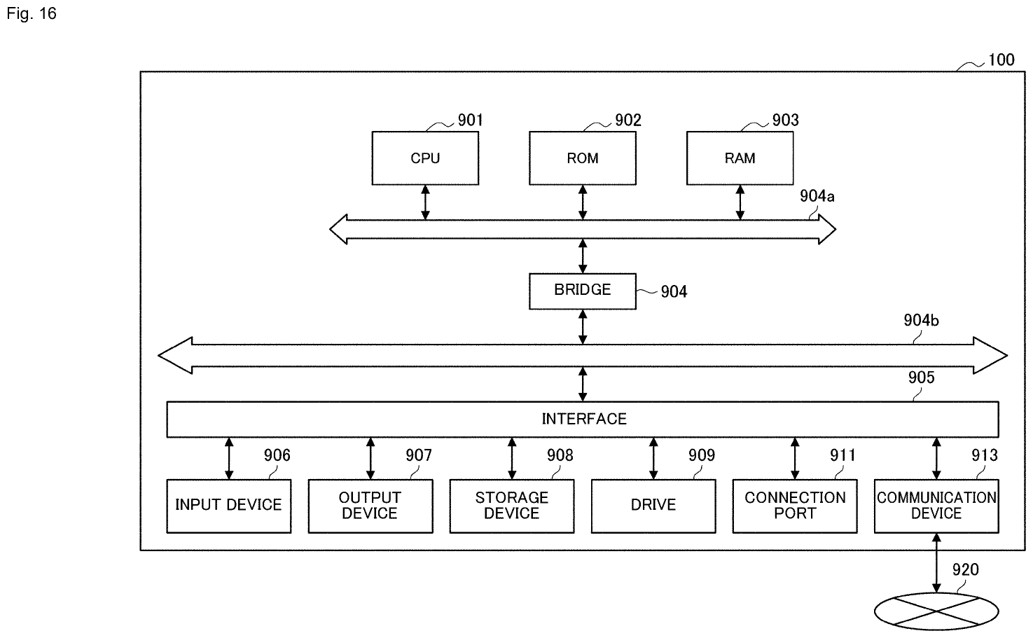

The hardware configuration of the information processing device 100 according to the present embodiment will be described next with reference to FIG. 16. FIG. 16 is a block diagram illustrating an example of the hardware configuration of the information processing device 100 according to the present embodiment.

The functions of the information processing device 100 according to the present embodiment can be implemented through software, and the hardware described hereinafter, working cooperatively. The functions of the point cloud generation unit 101, the position/attitude estimation unit 102, the target object shape estimation unit 110, and the position/attitude determination unit 107 may be implemented by a CPU 901, for example. The functions of the basic shape model storage unit 108 may be implemented by a storage device 908, for example.

As illustrated in FIG. 16, the information processing device 100 includes a Central Processing Unit (CPU) 901, a Read-Only Memory (ROM) 902, and a Random Access Memory (RAM) 903.

The information processing device 100 may further include a host bus 904a, a bridge 904, an external bus 904b, an interface 905, an input device 906, an output device 907, the storage device 908, a drive 909, a connection port 911, or a communication device 913. The information processing device 100 may have a processing circuit such as a Digital Signal Processor (DSP) or Application Specific Integrated Circuit (ASIC) instead of or in addition to the CPU 901.

The CPU 901 functions as an arithmetic processing device or a control device, and controls the operations in the information processing device 100 according to various programs recorded in the ROM 902, the RAM 903, the storage device 908, or a removable recording medium. The ROM 902 stores programs used by the CPU 901, computation parameters, and the like. The RAM 903 temporarily stores programs used for execution by the CPU 901, parameters used during the execution, and the like.

The CPU 901, the ROM 902, and the RAM 903 are connected to each other by the host bus 904a, which is capable of high-speed data transmission. The host bus 904a is connected to the external bus 904b, which is a Peripheral Component Interconnect/Interface (PCI) bus or the like, by the bridge 904, and the external bus 904b is connected to various components through the interface 905.

The input device 906 is a device that accepts inputs made by a user, such as a mouse, a keyboard, a touch panel, buttons, switches, levers, or the like, for example. Note that the input device 906 may be a microphone or the like that detects a user's voice. The input device 906 may be, for example, a remote control device using infrared light or other radio waves, or may be an externally-connected device that handles operations by the information processing device 100.

The input device 906 further includes an input control circuit that outputs, to the CPU 901, an input signal generated based on information input by a user. The user can input various types of data to the information processing device 100, or instruct the information processing device 100 to perform processing operations, by operating the input device 906.

The output device 907 is a device capable of visually or audibly presenting information obtained or generated by the information processing device 100 to the user. The output device 907 may be, for example, a display device such as a Liquid Crystal Display (LCD), a Plasma Display Panel (PDP), an Organic Light Emitting Diode (OLED) display, a hologram device, a projector, or the like, a sound output device such as a speaker or headphone, or a printing device such as a printer. The output device 907 can output information obtained from processing by the information processing device 100 as text or images, or as a sound such as voice or audio.

The storage device 908 is a data storage device configured as an example of a storage unit of the information processing device 100. The storage device 908 may be configured as, for example, a magnetic storage device such as a Hard Disk Drive (HDD), a semiconductor storage device, an optical storage device, or a magneto-optical storage device. The storage device 908 can store programs executed by the CPU 901, various types of data, various types of data obtained from the exterior, or the like.

The drive 909 is a device that reads from or writes to a removable recording medium such as a magnetic disk, an optical disk, a magneto-optical disk, a semiconductor memory, or the like, and is built into or external to the information processing device 100. For example, the drive 909 can read out information recorded in an attached removable recording medium, and output the information to the RAM 903. The drive 909 can also write records to the attached removable recording medium.

The connection port 911 is a port for connecting an externally-connected device directly to the information processing device 100. The connection port 911 may be a Universal Serial Bus (USB) port, an IEEE 1394 port, a Small Computer System Interface (SCSI) port, or the like, for example. The connection port 911 may also be an RS-232C port, an optical audio terminal, a High-Definition Multimedia Interface (HDMI; registered trademark) port, or the like. The connection port 911 can send and receive various types of data between the information processing device 100 and the externally-connected device by being connected to the externally-connected device.

The communication device 913 is a communication interface constituted by a communication device or the like for connecting to a communication network 920, for example. The communication device 913 may be a communication card for a wired or wireless Local Area Network (LAN), Wi-Fi (registered trademark), Bluetooth (registered trademark), Wireless USB (WUSB), or the like, for example. The communication device 913 may be a router for optical communication, a router for an Asymmetric Digital Subscriber Line (ADSL), or a modem for various types of communication.

The communication device 913 can, for example, send and receive signals to and from the Internet or other communication devices using a predetermined protocol such as TCP/IP. The communication network 920 connected to the communication device 913 is a network connected by a wire or wirelessly. The communication network 920 may be, for example, an Internet communication network, a household LAN, an infrared communication network, a radio wave communication network, a satellite communication network, or the like.

Note that it is also possible to create a program for causing hardware such as the CPU 901, the ROM 902, and the RAM 903 built into the computer to perform functions equivalent to those of the information processing device 100 described above. A computer-readable recording medium on which the program is recorded can also be provided.

Although preferred embodiments of the present disclosure have been described in detail thus far with reference to the accompanying drawings, the technical scope of the present disclosure is not limited to such examples. It will be apparent that those having ordinary knowledge in the technical field of the present disclosure can conceive of many variations or modification within the scope of the technical spirit set forth in the claims, and these should naturally be understood as falling within the technical scope of the present disclosure.

Further, the effects described in the present specification are merely explanatory or exemplary, and are not intended as limiting. In other words, the techniques according to the present disclosure may exhibit other effects apparent to those skilled in the art from the present descriptions, in addition to or instead of the above effects.

Further, the following configurations also fall within the technical scope of the present disclosure.
(1) An information processing device including:
   a position/attitude estimation unit that, taking each of points included in point cloud data generated based on a sensing result for a target object as contact points, estimates, for each of the points, candidates for a position and an attitude of a hand that grips the target object;
   a target object shape estimation unit that estimates a shape of the target object based on a distribution of the candidates for the position and the attitude estimated for each of the points; and a position/attitude determination unit that determines the position and the attitude of the hand gripping the target object based on the shape of the target object estimated.
(2)
   The information processing device according to (1), wherein the position/attitude estimation unit estimates the candidates for the position and the attitude of the hand using machine learning.
(3)
   The information processing device according to (2), wherein the position/attitude estimation unit further derives a confidence level for each of the candidates for the position and the attitude estimated.
(4)
   The information processing device according to (3), wherein the target object shape estimation unit estimates the shape of the target object based on the distribution of the candidates for the position and the attitude for which the confidence level is at least a threshold.
(5)
   The information processing device according to any one of (1) to (4), wherein the target object shape estimation unit estimates a distribution of a grip center of the target object based on the distribution of the candidates for the position and the attitude, and estimates the shape of the target object based on the distribution of the grip center of the target object.
(6)
   The information processing device according to (5), wherein the target object shape estimation unit estimates the grip center of the target object based on a geometric shape of the hand in the candidates for the position and the attitude.
(7)
   The information processing device according to (5) or (6), wherein the target object shape estimation unit derives an orthogonal basis of the distribution of the grip center of the target object through principal component analysis on the distribution of the grip center, and estimates the shape of the target object based on a distribution width for each point included in the point cloud data in each of vector directions of the orthogonal basis.
(8)
   The information processing device according to (7), wherein the orthogonal basis includes a first principal component vector, a second principal component vector, and a third principal component vector orthogonal to each other.
(9)
   The information processing device according to (7) or (8), wherein the target object shape estimation unit estimates the shape of the target object based on a magnitude relationship between: the distribution width for each point included in the point cloud data in each of the vector directions; and a maximum grip width of the hand.
(10)
   The information processing device according to (9), wherein the target object shape estimation unit estimates the shape of the target object by approximating the shape of the target object to a basic shape of any one of a sphere, a cylinder, or a rectangular plate.
(11)
   The information processing device according to (9), wherein the target object shape estimation unit estimates the shape of the target object by approximating the shape of the target object to any one of an ellipsoid, a cylinder having a radius that varies along a height direction, or a rectangular plate having a thickness that varies from region to region of a main surface.
(12)
   The information processing device according to (10) or (11), wherein the position/attitude determination unit determines the position and the attitude of the hand based on a constraint condition on a degree of freedom of the position and the attitude set for each of the basic shapes.
(13)
   The information processing device according to (10), wherein when the shape of the target object is not approximated to the basic shape, the position/attitude determination unit determines the position and the attitude of the hand from among the candidates for the position and the attitude estimated by the position/attitude estimation unit.
(14)
   The information processing device according to (7) or (8), wherein the target object shape estimation unit estimates the shape of the target object by fitting the distribution for each of the points included in the point cloud data of the target object to a predetermined shape model.
(15)
   The information processing device according to (14), wherein the target object shape estimation unit fits the position and the attitude of the target object with a position and an attitude of the predetermined shape model by superimposing the orthogonal basis of the distribution of the grip center of the target object and the orthogonal basis of the predetermined shape model.
(16)
   The information processing device according to any one of (1) to (15), wherein the sensing result includes a sensing result from a range sensor.
(17)
   An information processing method performed by an arithmetic processing device, the information processing method including:
   estimating, having taken each of points included in point cloud data generated based on a sensing result for a target object as contact points, candidates for a position and an attitude of a hand that grips the target object, for each of the points; estimating a shape of the target object based on a distribution of the candidates for the position and the attitude estimated for each of the points; and determining the position and the attitude of the hand gripping the target object based on the shape of the target object estimated.

### REFERENCE SIGNS LIST

1 Manipulation device
2 Target object
11 Hand
12 Range sensor
13 Arm part
100, 100A Information processing device
101 Point cloud generation unit
102 Position generation estimation unit
103 Candidate extraction unit
104 Center position derivation unit
105 Distribution analysis unit
106 Shape approximation unit
107 Position/attitude determination unit
108 Basic shape model storage unit
108A Known shape model storage unit
109 Fitting unit
110, 110A Target object shape estimation unit

1. An information processing device comprising:
a position/attitude estimation unit that, taking each of points included in point cloud data generated based on a sensing result for a target object as contact points, estimates, for each of the points, candidates for a position and an attitude of a hand that grips the target object;
a target object shape estimation unit that estimates a shape of the target object based on a distribution of the candidates for the position and the attitude estimated for each of the points; and
a position/attitude determination unit that determines the position and the attitude of the hand gripping the target object based on the shape of the target object estimated.

2. The information processing device according to claim 1,
wherein the position/attitude estimation unit estimates the candidates for the position and the attitude of the hand using machine learning.

3. The information processing device according to claim 2,
wherein the position/attitude estimation unit further derives a confidence level for each of the candidates for the position and the attitude estimated.

4. The information processing device according to claim 3,
wherein the target object shape estimation unit estimates the shape of the target object based on the distribution of the candidates for the position and the attitude for which the confidence level is at least a threshold.

5. The information processing device according to claim 1,
wherein the target object shape estimation unit estimates a distribution of a grip center of the target object based on the distribution of the candidates for the position and the attitude, and estimates the shape of the target object based on the distribution of the grip center of the target object.

6. The information processing device according to claim 5,
wherein the target object shape estimation unit estimates the grip center of the target object based on a geometric shape of the hand in the candidates for the position and the attitude.

7. The information processing device according to claim 5,
wherein the target object shape estimation unit derives an orthogonal basis of the distribution of the grip center of the target object through principal component analysis on the distribution of the grip center, and estimates the shape of the target object based on a distribution width for each point included in the point cloud data in each of vector directions of the orthogonal basis.

8. The information processing device according to claim 7,
wherein the orthogonal basis includes a first principal component vector, a second principal component vector, and a third principal component vector orthogonal to each other.

9. The information processing device according to claim 7,
wherein the target object shape estimation unit estimates the shape of the target object based on a magnitude relationship between: the distribution width for each point included in the point cloud data in each of the vector directions; and a maximum grip width of the hand.

10. The information processing device according to claim 9,
wherein the target object shape estimation unit estimates the shape of the target object by approximating the shape of the target object to a basic shape of any one of a sphere, a cylinder, or a rectangular plate.

11. The information processing device according to claim 9,
wherein the target object shape estimation unit estimates the shape of the target object by approximating the shape of the target object to any one of an ellipsoid, a cylinder having a radius that varies along a height direction, or a rectangular plate having a thickness that varies from region to region of a main surface.

12. The information processing device according to claim 10,
wherein the position/attitude determination unit determines the position and the attitude of the hand based on a constraint condition on a degree of freedom of the position and the attitude set for each of the basic shapes.

13. The information processing device according to claim 10,
wherein when the shape of the target object is not approximated to the basic shape, the position/attitude determination unit determines the position and the attitude of the hand from among the candidates for the position and the attitude estimated by the position/attitude estimation unit.

14. The information processing device according to claim 7,
wherein the target object shape estimation unit estimates the shape of the target object by fitting the distribution for each of the points included in the point cloud data of the target object to a predetermined shape model.

15. The information processing device according to claim 14,
wherein the target object shape estimation unit fits the position and the attitude of the target object with a position and an attitude of the predetermined shape model by superimposing the orthogonal basis of the distribution of the grip center of the target object and the orthogonal basis of the predetermined shape model.

16. The information processing device according to claim 1,
wherein the sensing result includes a sensing result from a range sensor.

17. An information processing method performed by an arithmetic processing device, the information processing method comprising:
estimating, having taken each of points included in point cloud data generated based on a sensing result for a target object as contact points, candidates for a position and an attitude of a hand that grips the target object, for each of the points;
estimating a shape of the target object based on a distribution of the candidates for the position and the attitude estimated for each of the points; and
determining the position and the attitude of the hand gripping the target object based on the shape of the target object estimated.
